(19) United States
(12) Patent Application Publication
(10) Pub. No.: US 2026/0213158 A1
(43) Pub. Date: Jul. 23, 2026

(54) COMPOSITE MATERIAL FOR ELECTRODES, ELECTRICITY STORAGE DEVICE, AND METHOD OF MANUFACTURING COMPOSITE MATERIAL FOR ELECTRODES

(71) Applicant: TOHOKU UNIVERSITY, Sendai-shi, Miyagi (JP)

(72) Inventors: Yuta NAKAYASU, Sendai-shi (JP); Masaru WATANABE, Sendai-shi (JP); Shu SOKABE, Sendai-shi (JP)

(73) Assignee: TOHOKU UNIVERSITY, SENDAI-SHI, MIYAGI (JP)

(21) Appl. No.: 19/158,153

(22) PCT Filed: Nov. 7, 2023
(86) PCT No.: PCT/JP2023/040116

§ 371 Date: Aug. 20, 2025

(30) Foreign Application Priority Data
Mar. 1, 2023 (JP) 2023-031112

(51) Int. Cl. H01M 4/137; H01M 4/02; H01M 4/1399; H01M 4/60; H01M 4/62

(52) U.S. Cl. CPC H01M 4/137; H01M 4/1399; H01M 4/608; H01M 4/625; H01M 2004/021; H01M 2004/027; H01M 2004/028

(57) ABSTRACT

A composite material for electrodes and an electricity storage device having a large support amount of an organic active material, and a method of manufacturing a composite material for electrodes capable of increasing support amount of organic active material. The composite material for electrodes has a porous carbon material and an organic active material supported within pores of porous carbon material. The organic active material is included in 28 wt % or more relative to total weight of porous carbon and organic active material. A porous carbon and an organic active material are maintained for a predetermined time in supercritical carbon dioxide between 70° C. to 170° C. and 20 MPa to 30 MPa, or between 90° C. to 170° C. and 13 MPa to 20 MPa impregnate organic active material within pores of porous carbon material, thereby manufacturing a composite material for electrodes having organic active material supported within pores of porous carbon material.

### FIELD OF THE INVENTION

The present invention relates to a composite material for electrodes, an electricity storage device, and a method of manufacturing the composite material for electrodes.

### DESCRIPTION OF RELATED ART

Conventionally, electricity storage devices having an electrode material comprising an organic material instead of a rare metal have been developed. For example, electrochemical capacitors have been developed, such as those including tetrachlorohydroquinone (TCHQ) supported on a porous body as a positive electrode material and those including dichloroanthraquinone (DCAQ) supported on a porous body as a negative electrode material (see, for example, Patent Literature 1 or the Non-Patent Literature 1 or 2).

So-called liquid impregnation is widely used as a method of manufacturing an electrode material for these electricity storage devices. In this method, a quinone compound and a porous body such as activated charcoal are dispersed in a liquid organic solvent such as acetone, and then the organic solvent is evaporated to enable the quinone compound to be supported within the pores of the porous body (see, for example, Patent Literature 1, Non-Patent Literatures 1 or 2). As a method other than the liquid impregnation, vapor phase impregnation may also be used in which a quinone compound is supported within the pores of a porous body by vapor deposition (see, for example, Non-Patent Literature 3).

### CITATION LIST

### Patent Literature

Patent Literature 1: WO2014/156511

### Non-Patent Literature

Non-Patent Literature 1: T. Tomai, S. Mitani, D. Komatsu, Y. Kawaguchi, I. Honma, “Metal-free aqueous redox capacitor via proton rocking-chair system in an organic-based couple”, Sci. Rep., 2014, 4, 3591
Non-Patent Literature 2: Y. Katsuyama et al., “Series module of quinone-based organic supercapacitor (>6 V) with practical cell structure”, Sci. Rep., 2022, 12, 3915
Non-Patent Literature 3: J. M. Blackburn et al., “Deposition of Conformal Copper and Nickel Films from Supercritical Carbon Dioxide”, Science, 2001, 294, p. 141-145

### SUMMARY OF THE INVENTION

### Problems to be Solved by the Invention

However, while electrode materials manufactured by liquid impregnation for use in, for example, the electricity storage devices as described in Patent Literature 1, Non-Patent Literatures 1 and 2 enable an organic active material such as quinone to be dissolved in an organic solvent at relatively high concentration, the interfacial surface tension of the resulting liquid may be large, and thus the organic active material may be difficult be delivered deep into the pores of the porous body. Therefore, they suffer from a problem in that the support amount of an organic active material is limited. For example, conventional liquid impregnation shows that the maximum support amount of an organic active material is limited to about 30 wt %. Moreover, in the vapor phase impregnation as described in Non-Patent Literature 3, an organic active material such as quinone can be delivered deep into the pores of the porous body by virtue of low interfacial surface tension and high diffusibility, but the low density of the organic active material results in a problem in that a very little amount of the organic active material can actually be supported.

The present invention is made in view of these problems. An object of the present invention is to provide a composite material for electrodes and an electricity storage device having a large support amount of an organic active material, and is to provide a method of manufacturing a composite material for electrodes capable of increasing the support amount of an organic active material.

### Means for Solving the Problems

To achieve the above objects, a composite material for electrodes according to the present invention has a porous carbon material and an organic active material supported in the pores of the porous carbon material, in which the organic active material is included in an amount of 28 wt % or more relative to the total weight of the porous carbon material and the organic active material.

In the composite material for electrodes according to the present invention, the organic active material supported in the pores of the porous carbon material is included in an amount of 28 wt % or more relative to the total weight of the porous carbon material and the organic active material, and the support amount of the organic material is large, and the organic active material is supported deep into the pores of the porous carbon material. Consequently, when it is used as an electrode of an electricity storage device, the specific capacity of the electricity storage device can be enhanced.

In the composite material for electrodes according to the present invention, the organic active material is preferably included in an amount of 35 wt % or more relative to the total weight of the porous carbon material and the organic active material. In this case, the organic active material is supported even deeper into the pores of the porous carbon material, and the support amount of the organic active material is even larger.

Further, in the composite material for electrodes according to the present invention, the organic active material is preferably supported within the pores so as to occupy 70% or more of pore volumes with a diameter of 1 to 1.5 nm among the pores of the porous carbon material. The organic active material is more preferably supported within the pores so as to occupy 80% or more of the pore volumes with a diameter of 1 to 1.5 nm. In these cases, the organic active material is also supported deep into the pores of the porous carbon material, and the support amount of the organic active material is large.

In the composite material for electrodes of the present invention, the organic active material may be supported within the pores so as to occupy 60% or more of the pore volumes with a diameter of less than 1 nm among the pores of the porous carbon material. Further, it may be supported within the pores so as to occupy 80% or more of the pore volumes with a diameter of less than 1 nm. In these cases, the organic active material is supported deep into smaller pores among the pores of the porous carbon material, and the support amount of the organic active material is even larger.

The method of manufacturing a composite material for electrodes according to the present invention comprises: maintaining a porous carbon material and an organic active material for a predetermined time in supercritical carbon dioxide at 70° C. or more to 170° C. or less and 10 MPa or more to 30 MPa or less, or 90° C. or more and 170° C. or less and 10 MPa or more to 20 MPa or less to impregnate the organic active material within the pores of the porous carbon material, thereby manufacturing the composite material for electrodes having the organic active material supported within the pores of the porous carbon material.

The method of manufacturing a composite material for electrodes according to the present invention can suitably manufacture the composite material for electrodes according to the present invention. According to the method of manufacturing a composite material for electrodes, the organic active material can be dissolved at a high concentration in supercritical carbon dioxide, and the resulting solution has a low interfacial surface tension and high diffusibility. Therefore, the organic active material can be delivered and supported deep into the pores of the porous carbon material. This can increase the support amount of the organic active material in the composite material for electrodes manufactured. According to the method of manufacturing a composite material for electrodes, supercritical carbon dioxide is preferably at 70° C. or more to 170° C. or less and 20 MPa or more to 30 MPa or less, or at 90° C. or more to 170° C. or less and 13 MPa or more to 20 MPa or less.

Alternatively, according to the method of manufacturing a composite material for electrodes, the supercritical carbon dioxide is preferably at 70° C. or more to 90° C. or less and 10 MPa or more to 30 MPa or less, or at 90° C. or more and 130° C. or less and 10 MPa or more to 20 MPa or less in order to manufacture the composite material for electrodes for used as positive electrodes. In particular, supercritical carbon dioxide is preferably at 70° C. or more to 90° C. or less and 20 MPa or more to 30 MPa or less, or at 90° C. or more to 130° C. or less and 13 MPa or more to 20 MPa or less. Alternatively, the supercritical carbon dioxide is preferably at 130° C. or more to 170° C. or less and 10 MPa or more to 30 MPa or less in order to manufacture the composite material for electrodes for use as negative electrodes. In particular, supercritical carbon dioxide is preferably at 130° C. or more to 170° C. or less and 13 MPa or more to 30 MPa or less. In these cases, when the composite materials for electrodes for use as positive and negative electrodes to be manufactured are used as electrodes of an electricity storage device, the specific capacity of the electricity storage device can be particularly enhanced.

According to the method of manufacturing a composite material for electrodes, the predetermined time is preferably 3 hours or more, and the predetermined time is in particular preferably 20 hours or more. In this case, more organic active material can be impregnated within the pores of the porous carbon material, further increasing the support amount of the organic active material.

According to the method of manufacturing a composite material for electrodes, preferably, a polar solvent as an entrainer is added to the supercritical carbon dioxide and maintained for the predetermined time, thereby manufacturing the composite material for electrodes. When an organic active material has polarity, it may be difficult to dissolve the organic active material in supercritical carbon dioxide because supercritical carbon dioxide is a non-polar solvent. However, the addition of a polar solvent as an entrainer enables the organic active material to be dissolved more easily in supercritical carbon dioxide. This can increase the support amount of the organic active material. According to the method of manufacturing a composite material for electrodes, the predetermined time is preferably 60 hours or more when manufacturing the composite material for electrodes for use as negative electrodes. In this case, the support amount of the organic active material in the composite material for electrodes for use as negative electrodes to be manufactured can be particularly increased, and the specific capacity of an electricity storage device can be particularly enhanced when it is used as an electrode of the electricity storage device. It is noted that the predetermined time is preferably 60 hours or less when a composite material for electrodes for use as positive electrodes is manufactured.

In the composite material for electrodes according to the present invention and the method of manufacturing a composite material for electrodes according to the present invention, the organic active material preferably includes a quinone compound, croconic acid, or metal phthalocyanine. More specifically, the followings may be used as an organic active material for positive electrodes: for example, p-benzoquinone, o-benzoquinone, thianthrene, 2,2,6,6-tetramethylpiperidine 1-oxyl (TEMPO), polyaniline, chloranil (tetrachloro-1,4-benzoquinone; CHL), tetrachlorohydroquinone (TCHQ), 2,5 dichloro 3,5 ethylhydroquinone, naphthhydroquinone, tetramino-p-benzoquinone, croconic acid, iron phthalocyanine, copper phthalocyanine, derivatives thereof, and the like. The followings may be used as an organic active material for negative electrodes: for example 1,4-dichloroanthraquinone (DCAQ), 1,5-dichloroanthraquinone, 1,8-dichloroanthraquinone, anthraquinone (AQ), 5,12-naphthacene quinone, naphthoquinone, 5,7,12,14-pentacenetetron, 1,2,4,8,9,11-hexachloro 5,7,12,14-pentacenetetron, 1,2,3,4,8,9,10,11-octachloro 5,7,12,14-pentacenetetron, 1,2,3,4,8,9,10,11,13-octachloro 5,7,12,14-pentacenetetron, tetracyanoxylene, benzenediimide, naphthalenediimide, fluorenone, dibenzothiophene 5,5-dioxide, derivatives thereof, and the like.

For the composite material for electrodes according to the present invention and the method of manufacturing a composite material for electrodes according to the present invention, the porous carbon material preferably consists of activated charcoal, and may also be nanocarbon such as graphene, carbon nanotube, and fullerene. The activated charcoal may also be any activated charcoal such as commercially available activated charcoal manufactured by gas activation, alkali activation, or the like, and it may be, for example, woody activated charcoal.

The electricity storage device according to the present invention has an electrode material including the composite material for electrodes according to the present invention, or an electrode material manufactured by the method of manufacturing a composite material for electrodes according to the present invention. The specific capacity of the electricity storage device according to the present invention can be enhanced by using these electrode materials.

### Advantageous Effects of the Invention

The present invention can provide a composite material for electrodes and an electricity storage device having a large support amount of an organic active material, and a method of manufacturing a composite material for electrodes capable of increasing the support amount of an organic active material.

### BRIEF DESCRIPTION OF THE DRAWINGS

FIG. 1 shows (a) the overall diagram of a manufacturing equipment; (b) the cross-sectional view of the inside of a container containing the materials, in a method of manufacturing a composite material for electrodes according to an embodiment of the present invention.

FIG. 2 shows (a) a graph of the results from the thermogravimetric analysis of each of the samples 1-1 to 1-12 and the comparative sample 1 prepared by liquid impregnation for positive electrodes; (b) a graph of the results from measurements of the specific surface area of each of the samples 1-1 to 1-12 for the positive electrodes, the comparative sample 1, and activated charcoal (AC), as the composite materials for electrodes according to the embodiments of the present invention.

FIG. 3 shows a front view of an electrochemical measurement equipment with a half-cell battery for the composite materials for electrodes according to the embodiments of the present invention.

FIG. 4 shows (a) a graph of the results from measurements of the specific capacity of a half-cell battery using each of the samples 1-1 to 1-12 and the comparative sample 1 for positive electrodes; (b) a graph of the relationship between potential and specific capacity (a redox curve) in a half-cell battery using the sample 1-6, the sample 1-8, and the comparative sample 1 for positive electrodes, for the composite materials for electrodes according to the embodiments of the present invention.

FIG. 5 shows a graph of the results from measurements of rate properties in a half-cell battery using the sample 1-6, the sample 1-8, and the comparative sample 1 for positive electrodes, for the composite materials for electrodes according to the embodiments of the present invention.

FIG. 6 shows graphs of redox curves at 0.1 A/g_{electlode}, 1 A/g_{electlode}, and 5 A/g_{electlode} of a half-cell battery using (a) the sample 1-6, (b) the sample 1-8, and (c) the comparative sample 1 for positive electrodes, for the composite materials for electrodes according to the embodiments of the present invention.

FIG. 7 shows a graph of the specific capacity per C-rate in a half-cell battery using the sample 1-8 and the comparative sample 1 for positive electrodes, for the composite materials for electrodes according to the embodiments of the present invention

FIG. 8 shows a graph of the results from measurements of cycle properties in a half-cell battery using the sample 1-6, the sample 1-8, and the comparative sample 1 for positive electrodes, for the composite materials for electrodes according to the embodiments of the present invention.

FIG. 9 shows a graph of the results from measurements of the pore size distribution of the sample 1-6, the sample 1-8, the comparative sample 1, and the activated charcoal (AC), for the composite materials for electrodes according to the embodiments of the present invention.

FIG. 10 shows graphs of (a) the pore volume of pores with a diameter of 1 nm or less; (b) the pore volume of pores with a diameter of 1 nm or more (1 to 1.5 nm) for each of the samples obtained from the results of measurements of the pore size distribution as shown in FIG. 9.

FIG. 11 shows a graph of the results from the measurements of the impregnation support amounts of chloranil, as determined by pyrolysis gas chromatography, of the samples 1-13 to 1-17 for positive electrodes with different impregnation times in supercritical carbon dioxide, for the composite materials for electrodes according to the embodiments of the invention.

FIG. 12 shows graphs of (a) the results from the measurements of the specific capacity; and (b) the relationship between potential and specific capacity, for the sample 1-15, the sample 1-16, and the sample 1-17 in which the impregnation time in supercritical carbon dioxide was 6 hours, 24 hours, and 72 hours, respectively, for the composite materials for electrodes according to the embodiments of the present invention.

FIG. 13 shows a graph of the results of thermogravimetric analysis for each of the samples 2-1 to 2-8 and the comparative sample 2 for negative electrodes, for the composite materials for electrodes according to the embodiments of the present invention.

FIG. 14 shows a graph of the results from the measurements of the specific surface area of each of the sample 2-6, the sample 2-8, the comparative sample 1, and the activated charcoal (AC) for negative electrodes, for the composite materials for electrodes according to the embodiments of the present invention.

FIG. 15 shows (a) a graph of the results from the measurements of specific capacity in a half-cell battery using the sample 2-4, the sample 2-5, the sample 2-6, the sample 2-8, and the comparative sample 2 for negative electrodes; (b) a graph of the relationship between potential and specific capacity (a redox curve) in a half-cell battery using the sample 2-6, the sample 2-8, and the comparative sample 2, for the composite materials for electrodes according to the embodiments of the present invention.

FIG. 16 shows a graph of the results from the measurements of rate properties in a half-cell battery using the sample 2-6, the sample 2-8, and the comparative sample 2 for the negative electrode, for the composite materials for electrodes according to the embodiments of the present invention.

FIG. 17 shows graphs of the redox curves at 0.1 A/g_{electlode}, 1 A/g_{electlode}, and 5 A/g_{electlode} of a half-cell battery using (a) the sample 2-6, (b) the sample 2-8, and (c) the comparative sample 2 for negative electrodes, for the composite materials for electrodes according to the embodiments of the present invention.

FIG. 18 shows a graph of the specific capacity per C-rate in a half-cell battery using the sample 2-8 and the comparative sample 2 for negative electrodes, for the composite materials for electrodes according to the embodiments of the present invention.

FIG. 19 shows a graph of the results from the measurements of cycle properties in a half-cell battery using the sample 2-8 and the comparative sample 2 for negative electrodes, for the composite materials for electrodes according to the embodiments of the present invention.

FIG. 20 shows a graph of the results from the measurements of pore size distribution of the sample 2-6, the sample 2-8, the comparison sample 2, and the activated charcoal (AC) for negative electrodes, for the composite materials for electrodes according to the embodiments of the present invention.

FIG. 21 shows graphs of (a) the pore volume of pores with a diameter of 1 nm or less; (b) the pore volume of pores with a diameter of 1 nm or more (1 to 1.5 nm) for each of the samples obtained from the results of the measurements of pore size distribution as shown in FIG. 20.

FIG. 22 shows a front view of an electrochemical measurement equipment with a full-cell battery using electrode materials comprising the sample 1-8 for positive electrodes and the sample 2-8 for negative electrodes, for the composite materials for electrodes according to the embodiments of the present invention.

FIG. 23 shows a graph of the redox curves for the positive and negative electrodes at 0.28 A/g, and the charge-discharge curve of the full cell battery as shown in FIG. 22.

FIG. 24 shows a graph of the results from the measurements of energy densities at 0.26 A/g and 2.6 A/g in the full-cell battery as shown in FIG. 22 and a full-cell battery comprising an electrode material prepared by liquid impregnation.

FIG. 25 shows a graph of the results from the measurements of rate properties in the full-cell battery as shown in FIG. 22.

FIG. 26 shows a graph of the charge-discharge curves of the full-cell battery as shown in FIG. 22 at 0.1 A/g_{electlode/2}, 1 A/g_{electlode/2}, and 5 A/g_{electlode/2}.

FIG. 27 shows graphs of (a) the charge-discharge curves and (b) the energy densities at the first cycle and the 1000th cycle of the cycle properties of the full-cell battery as shown in FIG. 22.

FIG. 28 shows a graph of a Ragone plot of power densities of the full cell battery as shown in FIG. 22, each of the conventional batteries, and the full cell battery comprising an electrode material prepared by liquid impregnation.

### DETAILED DESCRIPTION OF THE INVENTION

Hereinafter, the embodiments of the present invention will be described based on Examples and the like.

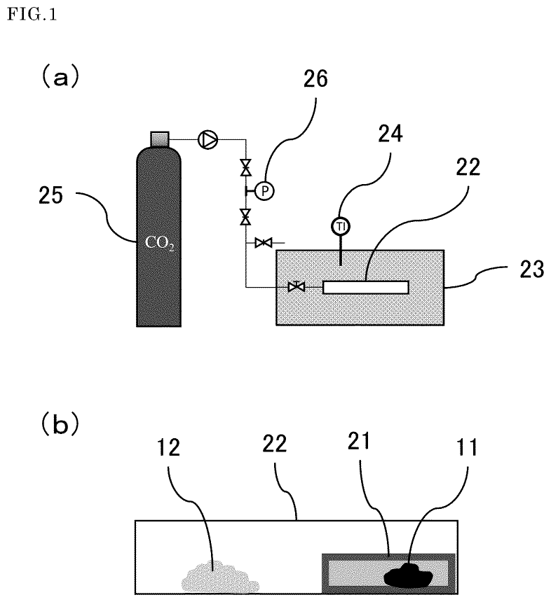

FIG. 1 through FIG. 28 show the composite materials for electrodes, the electricity storage devices, and the methods of manufacturing a composite material for electrodes according to the embodiments of the present invention.

The composite material for electrodes according to an embodiment of the present invention has a porous carbon material and an organic active material. The porous carbon material preferably consists of activated charcoal. The activated charcoal may be any activated charcoal such as commercially available activated charcoal manufactured by gas activation, alkali activation, or the like, and it may be, for example, woody activated charcoal. The porous carbon material may also be nano-carbon such as graphene, carbon nanotube, and fullerene.

The organic active material includes a quinone compound, croconic acid, or metal phthalocyanine, and is supported within the pores of the porous carbon material. The organic active material is supported within the pores so that the pore volumes with a diameter of 1 to 1.5 nm among the pores of the porous carbon material are decreased by 70% or more.

Specifically, the organic active material for positive electrodes may be, for example, p-benzoquinone, o-benzoquinone, thianthrene, 2,2,6,6-tetramethylpiperidine 1-oxyl (TEMPO), polyaniline, chloranil (tetrachloro-1,4-benzoquinone; CHL), tetrachlorohydroquinone (TCHQ), 2,5 dichloro 3,5 ethylhydroquinone, naphthhydroquinone, tetramino-p-benzoquinone, croconic acid, iron phthalocyanine, copper phthalocyanine, derivatives thereof, and the like. The organic active material for negative electrodes may be, for example 1,4-dichloroanthraquinone (DCAQ), 1,5-dichloroanthraquinone, 1,8-dichloroanthraquinone, anthraquinone (AQ), 5,12-naphthacene quinone, naphthoquinone, 5,7,12,14-pentacenetetron, 1,2,4,8,9,11-hexachloro 5,7,12,14-pentacenetetron, 1,2,3,4,8,9,10,11-octachloro 5,7,12,14-pentacenetetron, 1,2,3,4,6,8,9,10,11,13-octachloro 5,7,12,14-pentacenetetron, tetracyanoxylene, benzenediimide, naphthalenediimide, fluorenone, dibenzothiophene 5,5-dioxide, derivatives thereof, or the like.

The composite material for electrodes according to an embodiment of the present invention can be suitably manufactured by the method of manufacturing a composite material for electrodes according to an embodiment of the present invention. The method of manufacturing a composite material for electrodes according to an embodiment of the present invention comprises: maintaining a porous carbon material and an organic active material for a predetermined time in supercritical carbon dioxide at a predetermined temperature and pressure to impregnate the organic active material within the pores of the porous carbon material. This enables the manufacture of the composite material for electrodes according to an embodiment of the invention to be manufactured in which the organic active material is supported within the pores of the porous carbon material.

In the method of manufacturing a composite material for electrodes according to an embodiment of the invention, supercritical carbon dioxide is at 70° C. or more to 170° C. or less and 10 MPa or more to 30 MPa or less, or 90° C. or more to 170° C. or less and 10 MPa or more to 20 MPa or less. In particular, when the composite material for electrodes for use as positive electrodes is manufactured, supercritical carbon dioxide is preferably at 70° C. or more to 90° C. or less and 10 MPa or more to 30 MPa or less, or at 90° C. or more to 130° C. or less and 10 MPa or more to 20 MPa or less. When the composite material for electrodes for use as negative electrodes is manufactured, supercritical carbon dioxide is preferably at 130° C. or more to 170° C. or less and 10 MPa or more to 30 MPa or less. The time for maintaining the porous carbon material and the organic active material in supercritical carbon dioxide is 3 hours or more.

According to the method of manufacturing a composite material for electrodes according to an embodiment of the present invention, the organic active material can be dissolved at a high concentration in supercritical carbon dioxide, and the resulting solution has a low interfacial surface tension and high diffusibility. Therefore, the organic active material can be delivered and supported deep into the pores of the porous carbon material. Consequently, a composite material for electrodes having a large support amount of the organic active material can be manufactured.

It is noted that if an organic active material having polarity is used in the method of manufacturing a composite material for electrodes according to an embodiment of the present invention, the composite material for electrodes is preferably manufactured by adding a polar solvent as an entrainer to supercritical carbon dioxide and maintaining the porous carbon material and the organic active material for a predetermined time. In this case, it is difficult to dissolve the organic active material in supercritical carbon dioxide because supercritical carbon dioxide is a non-polar solvent. However, the addition of an entrainer as a polar solvent enables the organic active material to be dissolved more easily in supercritical carbon dioxide. This can increase the support amount of the organic active material. When the composite material for electrodes for use as negative electrodes is manufactured according to the method of manufacturing a composite material for electrodes according to an embodiment of the present invention, the time for maintaining the porous carbon material and the organic active material is preferably 60 hours or more. In this case, the composite material for electrodes for use as negative electrodes having a particularly large support amount of the organic active material can be manufactured.

The electricity storage device according to an embodiment of the invention has an electrode material including a composite material for electrodes according to an embodiment of the present invention, and/or an electrode material including a composite material for electrodes manufactured by the method of manufacturing a composite material for electrodes according to an embodiment of the invention. The specific capacity of the electricity storage device according to an embodiment of the present invention can be enhanced by using these electrode materials.

### Example 1

### [Manufacture of Composite Material for Electrodes for Use as Positive Electrodes]

Using the equipment as shown in FIG. 1, the samples of composite materials for electrodes for use as positive electrodes were manufactured by the methods of manufacturing a composite material for electrodes according to the embodiments of the present invention. As the materials, activated charcoal was used as a porous carbon material 11, and chloranil (manufactured by Tokyo Chemical Industry Co., Ltd.) was used as an organic active material 12. Commercially available Maxsorb (registered trademark: manufactured by Kansai Coke and Chemicals Co., LTD.) was used as activated charcoal.

For manufacturing the samples of the composite materials for electrodes, 0.1 g of activated charcoal as the porous carbon material 11 was first placed in a copper box 21 as shown in FIG. 1(b), and the box 21 and 1 g of chloranil as the organic active material 12 were placed in a tubular container 22 made of SUS316. Next, as shown in FIG. 1(a), the container 22 was placed in a water tank 23 filled with aluminum balls. Liquid carbon dioxide was introduced into the inside of the container 22 from a tank 25 while the water tank 23 was heated to a predetermined temperature by a heater arranged at the bottom of the water tank 23 and maintained at that temperature using a thermometer 24. At this time, carbon dioxide was introduced while adjusting the pressure to a predetermined level using a pressure gauge 26. After the predetermined pressure was stabilized, the introduction of carbon dioxide was stopped. The samples of the composite materials for electrodes were manufactured by maintaining the container 22 for 24 hours under the conditions (in a supercritical state) of the predetermined temperature and pressure.

The temperature and pressure conditions for the container 22 were combinations of 45° C., 75° C., 105° C., and 155° C. for the temperature, and 10 MPa, 15 MPa, and 25 MPa for the pressures; that is, a total of 12 different combinations of the conditions were used to manufacture the samples of the composite materials for electrodes. Moreover, in the case of the temperature and pressure conditions of 105° C. and 15 MPa, the samples were also manufactured as in the above except that the impregnation time in supercritical carbon dioxide was changed from 24 hours to 1 hour, 3 hours, 6 hours, and 72 hours, respectively. It is noted that the critical temperature of carbon dioxide is 31.1° C., and the critical pressure is 7.38 MPa.

A composite material for electrodes as a comparative sample was also manufactured by liquid impregnation as follows. First, 300 mg of chloranil as the organic active material 12 was dissolved in about 200 ml of acetone and sonicated for 10 minutes. After sonication, 70 mg of activated charcoal as the porous carbon material 11 was added to the resulting solution, and an additional 1 hour of sonication was performed to disperse the activated charcoal in the solution. Then, the solution was maintained at 60° C. with stirring to evaporate acetone, thereby manufacturing a comparative sample having chloranil supported in the pores of the activated charcoal. The conditions for manufacturing the samples are summarized and shown in Table 1.

TABLE 1

| | | Pressure | Temperature | Impregnation |
|---|---|---|---|---|
| Sample | | [MPa] | [° C.] | time [h] |
| Comparative sample 1 | | — | — | — |
| (AC_{_{—}}_{CHL}_{_{—}}_{L}) | | | | |
| 1-1 | (AC_{_{—}}_{CHL}_{_{—}}₄₅_{_{—}}₁₀) | 10 | 45 | 24 |
| 1-2 | (AC_{_{—}}_{CHL}_{_{—}}₄₅_{_{—}}₁₅) | 15 | 45 | 24 |
| 1-3 | (AC_{_{—}}_{CHL}_{_{—}}₄₅_{_{—}}₂₅) | 25 | 45 | 24 |
| 1-4 | (AC_{_{—}}_{CHL}_{_{—}}₇₅_{_{—}}₁₀) | 10 | 75 | 24 |
| 1-5 | (AC_{_{—}}_{CHL}_{_{—}}₇₅_{_{—}}₁₅) | 15 | 75 | 24 |
| 1-6 | (AC_{_{—}}_{CHL}_{_{—}}₇₅_{_{—}}₂₅) | 25 | 75 | 24 |
| 1-7 | (AC_{_{—}}_{CHL}_{_{—}}₁₀₅_{_{—}}₁₀) | 10 | 105 | 24 |
| 1-8 | (AC_{_{—}}_{CHL}_{_{—}}₁₀₅_{_{—}}₁₅) | 15 | 105 | 24 |
| 1-9 | (AC_{_{—}}_{CHL}_{_{—}}₁₀₅_{_{—}}₂₅) | 25 | 105 | 24 |
| 1-10 | (AC_{_{—}}_{CHL}_{_{—}}₁₅₅_{_{—}}₁₀) | 10 | 155 | 24 |
| 1-11 | (AC_{_{—}}_{CHL}_{_{—}}₁₅₅_{_{—}}₁₅) | 15 | 155 | 24 |
| 1-12 | (AC_{_{—}}_{CHL}_{_{—}}₁₅₅_{_{—}}₂₅) | 25 | 155 | 24 |
| 1-13 | (AC_{_{—}}_{CHL}_{_{—}}₁₀₅_{_{—}}₁₅_{_{—}}₁) | 15 | 105 | 1 |
| 1-14 | (AC_{_{—}}_{CHL}_{_{—}}₁₀₅_{_{—}}₁₅_{_{—}}₃) | 15 | 105 | 3 |
| 1-15 | (AC_{_{—}}_{CHL}_{_{—}}₁₀₅_{_{—}}₁₅_{_{—}}₆) | 15 | 105 | 6 |
| 1-16 | (AC_{_{—}}_{CHL}_{_{—}}₁₀₅_{_{—}}₁₅_{_{—}}₂₄) | 15 | 105 | 24 |
| 1-17 | (AC_{_{—}}_{CHL}_{_{—}}₁₀₅_{_{—}}₁₅_{_{—}}₇₂) | 15 | 105 | 72 |

### [Thermogravimetric Analysis (TG) and Measurements of Specific Surface Area (SSA)]

Thermogravimetric analysis and measurements of specific surface area were performed on each of the samples 1-1 to 1-12 and the comparative sample 1 of the composite materials for electrodes for use as positive electrodes manufactured. For thermogravimetric analysis, “TG/DTA6200 (EXSTAR6000 series, manufactured by Seiko Instruments, Inc.)” was used. For thermogravimetric analysis of each sample, the temperature was increased from 30° C. to 110° C. at a rate of 10° C./min and maintained for 20 minutes, and then the temperature was increased again to 400° C. (at 10° C./min) and maintained for 40 minutes at that temperature. These were performed while N₂ gas was purged at 200 ml/min. The difference between the weight after maintaining at 110° C. for 20 minutes and the weight after maintaining at 400° C. for 40 minutes was considered as the support amount of chloranil.

In the measurements of specific surface area, the nitrogen adsorption isotherm at 77 K was measured using an automatic specific surface area/pore size distribution measurement device, “Bellsorp Mini II (from Nippon Bell Co., Ltd.)” after degassing at 150° C. for 5 hours or more under a vacuum atmosphere. The adsorption isotherm measured was analyzed using the BET method to calculate the specific surface area.

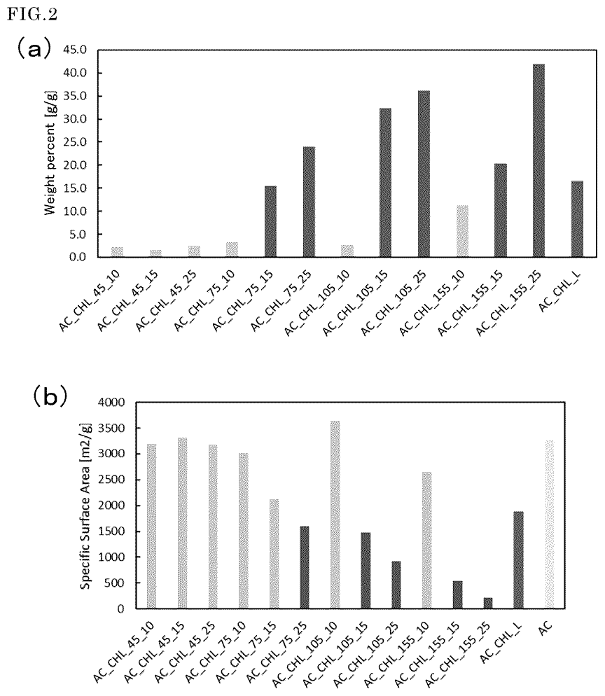

The results from thermogravimetric analysis and the results from the measurements of specific surface area are shown in FIGS. 2(a) and 2(b), respectively. It is noted that “AC” in FIG. 2(b) represents the specific surface area of the activated charcoal (the same applies hereinafter).

As shown in FIG. 2(a), the results from thermogravimetric analysis indicate that the support amount of chloranil for 6 samples: the sample 1-5 (AC_CHL_75_15), the sample 1-6 (AC_CHL_75_25), the sample 1-8 (AC_CHL_105_15), the sample 1-9 (AC_CHL_105_25), the sample 1-11 (AC_CHL_155_15), and the sample 1-12 (AC_CHL_155_25) was comparative to or larger than that of the comparative sample 1 (AC_CHL_L) prepared by liquid impregnation. This may suggest that the conditions of a high temperature and a high pressure are required to increase the support amount of chloranil. Moreover, it was found that the support amount was increased as the temperature increased at the same pressure, and the support amount was increased as the pressure increased at the same temperature. This may be because the solubility of chloranil in supercritical carbon dioxide (scCO2) was increased at an increased temperature and pressure, leading to an increased concentration of chloranil.

As shown in FIG. 2(b), the measurements of specific surface area indicate that the samples having a higher support amount of chloranil have smaller specific surface areas. This may be because chloranil is supported deeper into the pores of the activated charcoal, and more pores are filled from the back without gaps for the samples having a larger support amount.

### [Electrochemical Measurements in Half-Cell Battery]

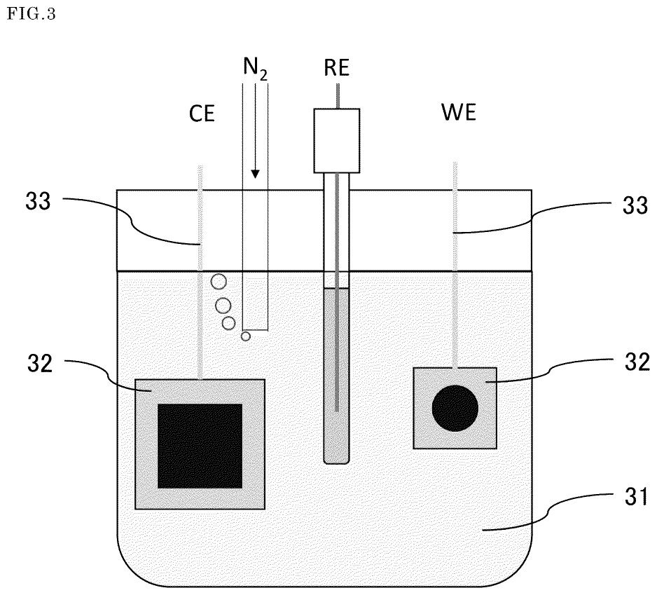

Electrochemical measurements were performed in a half-cell battery to determine the specific capacities, the rate properties, and the cycle properties. As shown in FIG. 3, a working electrode WE was prepared as follows: the powder of each sample was mixed with a polytetrafluoroethylene (PTFE) binder in a weight ratio of 9:1 to form a paste, which was rolled thinly to 0.2 mg/mm², and then punched out in a diameter of 5.5 mm, and pressure-fit on a gold mesh 32 which was welded to a gold wire 33. The working electrode WE as prepared in this way was used for the measurements. Ag/AgCl (manufactured by EC frontier Co., Ltd.) was used as a reference electrode RE. Further, a counter electrode CE was prepared as follows: activated charcoal (Maxsorb) and PTFE were mixed in a weight ratio of 9:1 to form a paste, which was then pressure-fit on the gold mesh 32 which was welded to the gold wire 33 so as to be 5 times the mass of the working electrode WE. The counter electrode CE prepared in this way was used. Moreover, an aqueous solution of 0.5 M H₂SO₄ was used as an electrolytic solution 31. Measurements were performed in the electrolytic solution 31 under nitrogen bubbling using an electrochemical measuring equipment (“SI 1280-2” from TOYO Corporation).

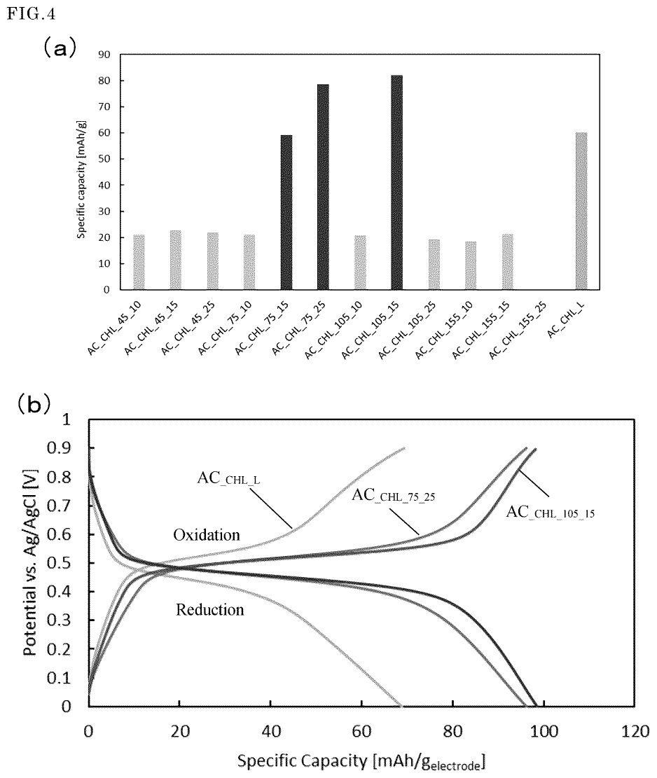

The results from the measurements of specific capacity are shown in FIG. 4(a). It is noted that in the measurements, constant current measurements were performed in the range of 0 to 0.9 V at 1 A/g_{electlode}, and a specific capacity at the fifth cycle was determined. The specific capacity was a capacity due to redox obtained by subtracting the electric double layer (EDL) capacity from the total capacity. As shown in FIG. 4(a), the specific capacities of 3 samples: the sample 1-5 (AC_CHL_75_15), the sample 1-6 (AC_CHL_75_25), and the sample 1-8 (AC_CHL_105_15) were found to be comparative to or larger than that of the comparative sample 1 (AC_CHL_L) prepared by liquid impregnation. In particular, the sample 1-8 was found to have a specific capacity of 82 mAh/g_{electrode}, which was about 1.4 times higher than that of the comparative sample 1. For these 3 samples, the support amount of chloranil was found to be comparative to or larger than that of the comparative sample prepared by liquid impregnation, as shown in FIG. 2(a). This indicates that the increase in the support amount of chloranil increased the amount of chloranil which contributed to redox. In contrast, the sample 1-9 (AC_CHL_105_25) and the sample 1-12 (AC_CHL_155_25) having a large support amount of chloranil were found to have a small specific capacity, as shown in FIG. 4(a). This may be because chloranil was excessively supported, resulting in occlusion of the pores.

FIG. 4(b) shows that the relationship between potential and specific capacity (redox curves) for 2 samples having a particularly large specific capacity: the sample 1-6 (AC_CHL_75_25) and the sample 1-8 (AC_CHL_105_15), and the comparative sample 1 (AC_CHL_L) prepared by liquid impregnation. As shown in FIG. 4(b), the sample 1-6 and the sample 1-8 prepared using supercritical carbon dioxide were found to have a significantly extended plateau region due to redox, a lower oxidation potential, a higher reduction potential, a lower overvoltage, and a lower resistance as compared with the comparative sample 1. This may be because in the case of liquid impregnation, chloranil agglomerates when the solvent evaporates, whereas in the case of supercritical carbon dioxide impregnation, chloranil is uniformly distributed on the surface, and chloranil agglomeration is less likely to occur when the solvent is desorbed, resulting in lower interface resistance.

The sample 1-8 (AC_CHL_105_15) having a large specific capacity and the comparative sample 1 (AC_CHL_L) were subjected to pyrolysis gas chromatography to determine the amount of Cl element for calculating the impregnated amount of CHL. The results are shown in Table 2. As shown in Table 2, the impregnation support amount of CHL was found to be about 26% for the comparative sample 1, whereas about 38% for the sample 1-8, which was about 1.46 times higher.

TABLE 2

| Sample Name | Cl [wt %] | CHL [wt %] |
|---|---|---|
| AC_{_{—}}_{CHL}_{_{—}}_{L} | 15 | 26.01 |
| AC_{_{—}}_{CHL}_{_{—}}₁₀₅_{_{—}}₁₅ | 22 | 38.15 |

Using the impregnation support amounts of CHL as shown in Table 2, the utilization rates of CHL at the specific capacities as shown in FIG. 4(a) was determined and shown in Table 3. As shown in Table 3, nearly 100% of CHL was found to contribute to the specific capacity for both of the samples. This may be because CHL is supported in a manner that the pores were not occluded. This can allow the electrolyte to reach the supported CHL, leading to sufficient oxidation and reduction. It is noted that the utilization rates as shown in Table 3 are more than 100%. This may be because in FIG. 4(b), the slope representing the electric double-layer capacity before the reduction of CHL is completed is greater than the slope representing the electric double-layer capacity after the reduction is completed.

TABLE 3

| | Theoretical | Practical | Utilization |
|---|---|---|---|
| | capacity | amount | rate |
| Sample Name | [mAh/g] | [mAh/g] | [%] |
| AC_{_{—}}_{CHL}_{_{—}}_{L} | 50.56 | 57.42 | 113.6 |
| AC_{_{—}}_{CHK}_{_{—}}₁₀₅_{_{—}}₁₅ | 74.16 | 81.05 | 109.3 |

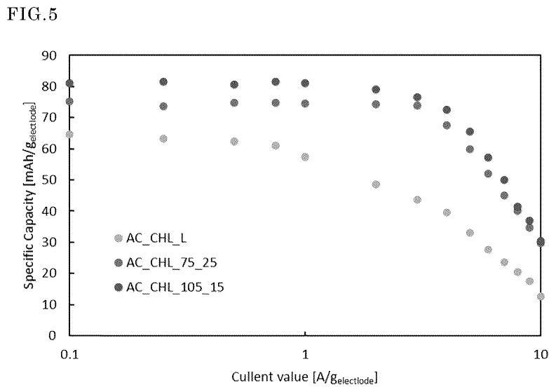

The results of the rate properties for the sample 1-6 (AC_CHL_75_25) and the sample 1-8 (AC_CHL_105_15) having a large specific capacity prepared by supercritical carbon dioxide and the comparative sample 1 (AC_CHL_L) prepared by liquid impregnation are shown in FIG. 5. It is noted that for the measurements of rate properties, constant current measurements were performed in the range of 0 to 0.9 V at 0.1 to 10 A/g_{electlode} for determining a specific capacity at the second cycle. As shown in FIG. 5, the sample 1-6 and the sample 1-8 prepared by supercritical carbon dioxide maintained a higher specific capacity at any current densities as compared with the comparative sample 1. For example, at a current density of 4 A/g, the specific capacity was found to be about 2 times higher than that of the comparative sample. Moreover, the two samples prepared by supercritical carbon dioxide were also found to maintain 90% of their capacity at 1 A/g, even at a current density of 3 A/g (corresponding to the 18C rate or higher). This may be due to a higher impregnation support amount of CHL as well as a lower interface resistance.

Further, the redox curves of the samples at 0.1 A/g_{electlode}, 1 A/g_{electlode}, and 5 A/g_{electlode} are shown in FIGS. 6(a) to 6(c), respectively. As shown in FIGS. 6(a) to 6(c), the sample 1-8 was found to have a lower overvoltage as compared with the sample 1-6 and the comparative sample 1. In the case of the comparative sample 1, overvoltage was found to be significantly increased as the current value increased. As a result of this, the specific capacity was found to be no longer maintained.

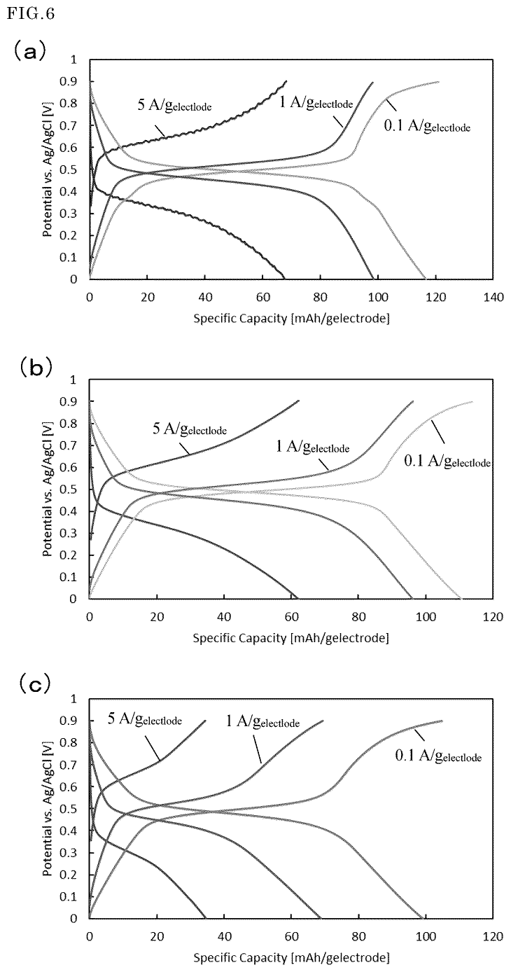

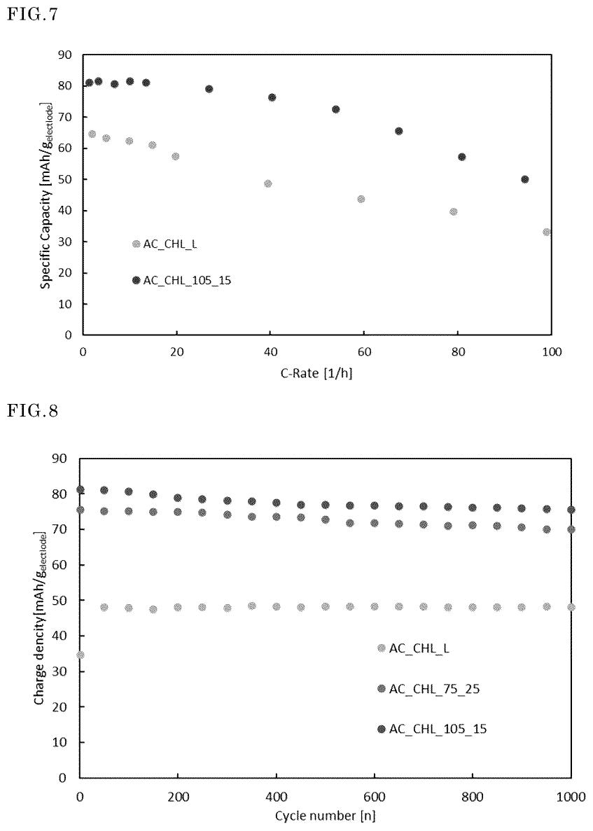

Moreover, the specific capacities per C-rate of the sample 1-8 and the comparative sample 1 are shown in FIG. 7. As shown in FIG. 7, the specific capacity of the sample 1-8 at the C-rate was also found to be larger than that of the comparative sample 1 at all the rates. This may show that CHL can be efficiently redoxed even at a high rate for the sample 1-8 prepared by supercritical carbon dioxide.

The results of the cycle properties for the sample 1-6 (AC_CHL_75_25) and the sample 1-8 (AC_CHL_105_15) having a large specific capacity prepared by supercritical carbon dioxide and the comparative sample 1 (AC_CHL_L) prepared by liquid impregnation are shown in FIG. 8. It is noted that for the measurements of cycle properties, constant current measurements of 1000 cycles were performed in the range of 0 to 0.9 V at 2 A/g_{electlode} to determine the specific capacity at every 50 cycles. As shown in FIG. 8, the sample 1-6 and the sample 1-8 prepared by supercritical carbon dioxide were found to show excellent durability with 93% of the specific capacity retained after 1000 cycles. It was also found that the specific capacities of the sample 1-6 and the sample 1-8 prepared by supercritical carbon dioxide were larger by 20 to 30 mAh/g_{electrode} than that of the comparative sample 1 even after 1000 cycles. This may be due to more robust adsorption of CHL supported on the pore surfaces of the activated charcoal by virtue of the π-π interaction.

### [Measurements of Pore Size Distribution]

The sample 1-6 (AC_CHL_75_25) and the sample 1-8 (AC_CHL_105_15) having a large specific capacity prepared by supercritical carbon dioxide, the comparative sample 1 (AC_CHL_L) prepared by liquid impregnation, and the activated charcoal (AC) were subjected to measurements of pore size distribution. In the measurements, degassing was performed at 120° C. for 5 hours or more under a vacuum atmosphere, and then the adsorption isotherm of carbon dioxide at 273 K was measured using an automated specific surface area and pore size analyzer (“QUADRASORB evo4” from Quantachrome Instruments). The adsorption isotherm measured was analyzed by the DFT method to determine the pore size distribution.

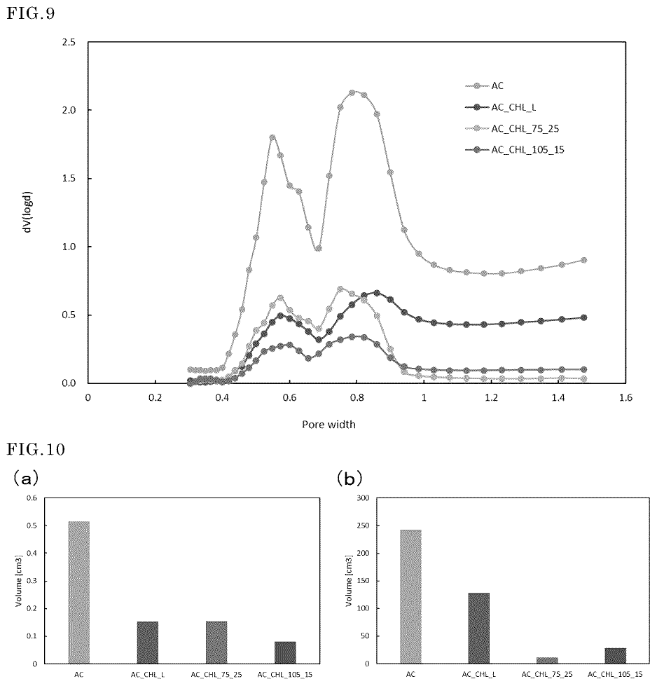

The results from the measurements of pore size distribution are shown in FIG. 9. From these results, the pore volume of pores having a diameter of 1 nm or less, and the pore volume of pores having a diameter of 1 nm or more were also calculated for each sample and are shown in FIGS. 10 (a) and 10(b), respectively. It is noted that the molecular size of chloranil is 5.31×5.48 angstrom.

As shown in FIGS. 9 and 10, the sample 1-6 and the sample 1-8 prepared by supercritical carbon dioxide and the comparative sample 1 were found to have a smaller pore volume than the activated charcoal at all the pore sizes. In the range of pore diameters of 1 nm or more (1 nm to 1.5 nm), the sample 1-6 and the sample 1-8 prepared by supercritical carbon dioxide were found to show a smaller pore volume than the comparative sample 1. Specifically, as shown in FIG. 10(b), the sample 1-6 was found to show about 96% decrease in the pore volume with a diameter of 1 nm or more (1 nm to 1.5 nm) of the activated charcoal, and the sample 1-8 was found to show about 89% decrease in the pore volume with a diameter of 1 nm or more (1 nm to 1.5 nm) of the activated charcoal.

In the range of pore diameters of 1 nm or less, the sample 1-8 prepared by supercritical carbon dioxide was found to have the smallest pore volume. Specifically, as shown in FIG. 10(a), the sample 1-6 was found to show about 70% decrease in the pore volume with a diameter of 1 nm or less of the activated charcoal, and the sample 1-8 was found to show about 84% decrease in the pore volume with a diameter of 1 nm or less of the activated charcoal. These results from the measurements of the pore size distribution suggest that chloranil supported in these pores may have a significant impact on the improvement of the specific capacity and other properties.

### [Effects of Impregnation Time]

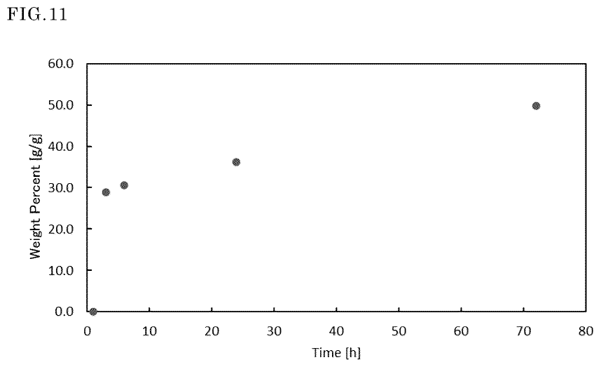

Pyrolysis gas chromatography was performed on the samples 1-13 to 1-17 with different impregnation times in supercritical carbon dioxide to determine the impregnation support amount of CHL. The results are shown in FIG. 11. As shown in FIG. 11, the support amount of CHL was found to rapidly increase from the start of impregnation to 6 hours, and then slowly increase after that. This may be because CHL was diffused over the surface of the activated charcoal and then diffused into the pores.

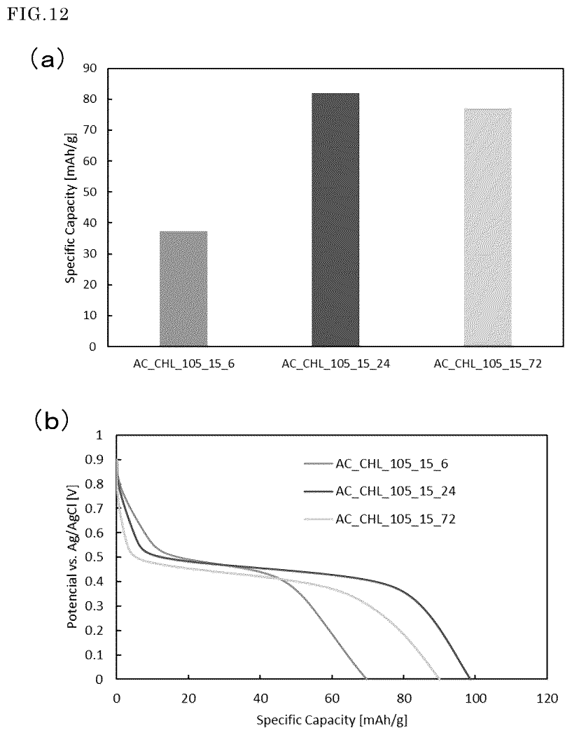

The sample 1-15 with an impregnation time of 6 hours, the sample 1-16 with an impregnation time of 24 hours, and the sample 1-17 with an impregnation time of 72 hours were subjected to constant current measurements as in FIG. 4 to determine their specific capacities. The results from the measurements of specific capacity are shown in FIG. 12(a), and the relationship between potential and specific capacity is shown in FIG. 12(b). As shown in FIG. 12, the sample 1-15 with an impregnation time of 6 hours was found to have a lower specific capacity than the sample 1-16 with an impregnation time of 24 hours. This may be because CHL was not supported the inside of the pores in the sample 1-15 with an impregnation time of 6 hours, and the supported CHL cannot be fully used. Moreover, the sample 1-17 with an impregnation time of 72 hours was found to have a slightly smaller specific capacity than the sample 1-16 with an impregnation time of 24 hours, despite the higher support amount of CHL. This may be because excess CHL was supported in a manner that it was laminated in multiple layers in the sample 1-17 with an impregnation time of 72 hours, resulting in an increased interface resistance.

### Example 2

### [Manufacture of Composite Material for Electrodes for Use as Negative Electrodes]

Using the equipment as shown in FIG. 1, the samples of composite materials for electrodes for use as negative electrodes were manufactured according to the method of manufacturing a composite material for electrodes as in Example 1. The materials were the same as in Example 1, except that the organic active material was 1,4-dichloroanthraquinone (DCAQ: manufactured by Tokyo Chemical Industry Co., Ltd.).

The samples of composite materials for electrodes for use as negative electrode were manufactured in a similar way as in Example 1, with 4 combinations of the temperature and pressure conditions: 75° C. and 25 MPa, 105° C. and 15 MPa, 155° C. and 15 MPa, and 155° C. and 25 MPa. In addition to those samples, the samples impregnated under the conditions of 155° C. and 25 MPa for 72 hours (3 days) and 144 hours (6 days) were also manufactured. The samples were also manufactured by adding 3.5 mol % of ethanol (EtOH) as an entrainer in carbon dioxide and maintaining it for 24 hours under the conditions of 155° C. and 15 MPa or 155° C. and 25 MPa. Moreover, the comparative sample of the composite material for electrodes was also manufactured by liquid impregnation as in Example 1, except that the organic active material was DCAQ. The conditions for manufacturing the samples are summarized and shown in Table 4.

TABLE 4

| | Pressure | Temperature | Impregnation |
|---|---|---|---|
| Sample | [MPa] | [° C.] | time [h] |
| Comparative sample 2 | — | — | — |
| (AC_{_{—}}_{DCAQ}_{_{—}}_{L}) | | | |
| 2-1 (AC_{_{—}}_{DCAQ}_{_{—}}₇₅_{_{—}}₂₅) | 25 | 75 | 24 |
| 2-2 (AC_{_{—}}_{DCAQ}_{_{—}}₁₀₅_{_{—}}₁₅) | 15 | 105 | 24 |
| 2-3 (AC_{_{—}}_{DCAQ}_{_{—}}₁₅₅_{_{—}}₁₅) | 15 | 155 | 24 |
| 2-4 (AC_{_{—}}_{DCAQ}_{_{—}}₁₅₅_{_{—}}₂₅) | 25 | 105 | 24 |
| 2-5 (AC_{_{—}}_{DCAQ}_{_{—}}₁₅₅_{_{—}}₂₅_{_{—}}₇₂) | 25 | 105 | 72 |
| 2-6 (AC_{_{—}}_{DCAQ}_{_{—}}₁₅₅_{_{—}}₂₅_{_{—}}₁₄₄) | 25 | 105 | 144 |
| 2-7 (AC_{_{—}}_{DCAQ}_{_{—}}₁₅₅_{_{—}}₁₅_{_{—}}_{E}) | 15 | 155 | 24 |
| 2-8 (AC_{_{—}}_{DCAQ}_{_{—}}₁₅₅_{_{—}}₂₅_{_{—}}_{E}) | 25 | 155 | 24 |

### [Thermogravimetric Analysis (TG) and Measurements of Specific Surface Area (SSA)]

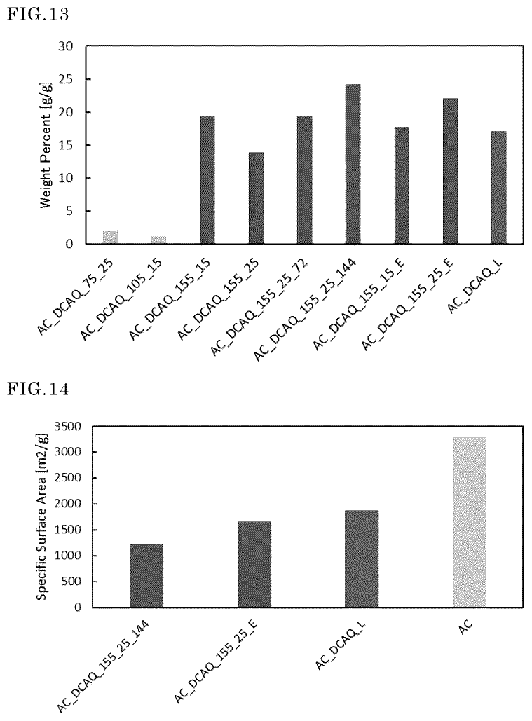

Thermogravimetric analysis was performed in a similar way as in Example 1 on each of the samples 2-1 to 2-8 and the comparative sample 2 of the composite materials for electrodes manufactured for use as negative electrodes. The results are shown in FIG. 13. As shown in FIG. 13, the following 5 samples manufactured under the temperature and pressure conditions and the like of the sample 2-3 (AC_DCAQ_155_15), the sample 2-5 (AC_DCAQ_155_25_72), the sample 2-6 (AC_DCAQ_155_25_144), the sample 2-7 (AC_DCAQ_155_15_E), and the sample 2-8 (AC_DCAQ_155_25_E) were found to have a larger support amount of DCAQ than the comparative sample 2 (AC_DCAQ_L) prepared by liquid impregnation. For the following 3 samples: the samples 2-4 to 2-6, the support amount was found to increase as the impregnation time increased. The higher support amounts of the sample 2-7 and the sample 2-8 having an entrainer is believed to be due to the enhanced solute-solvent interactions and the increased concentrations of DCAQ by the entrainer

The sample 2-6 (AC_DCAQ_155_25_144), the sample 2-8 (AC_DCAQ_155_25_E) having a large support amount of DCAQ, the comparative sample 2 (AC_DCAQ_L) prepared by liquid impregnation, and the activated charcoal (AC) were subjected to the measurements of specific surface area in a similar way as in Example 1. The results are shown in FIG. 14. As shown in FIG. 14, both the sample 2-6 and the sample 2-8, which had a large support amount, were found to have a small specific surface area. This may be because DCAQ is supported deep into the pores of the activated charcoal, filling the pores without gaps.

### [Electrochemical Measurements in Half-Cell Battery]

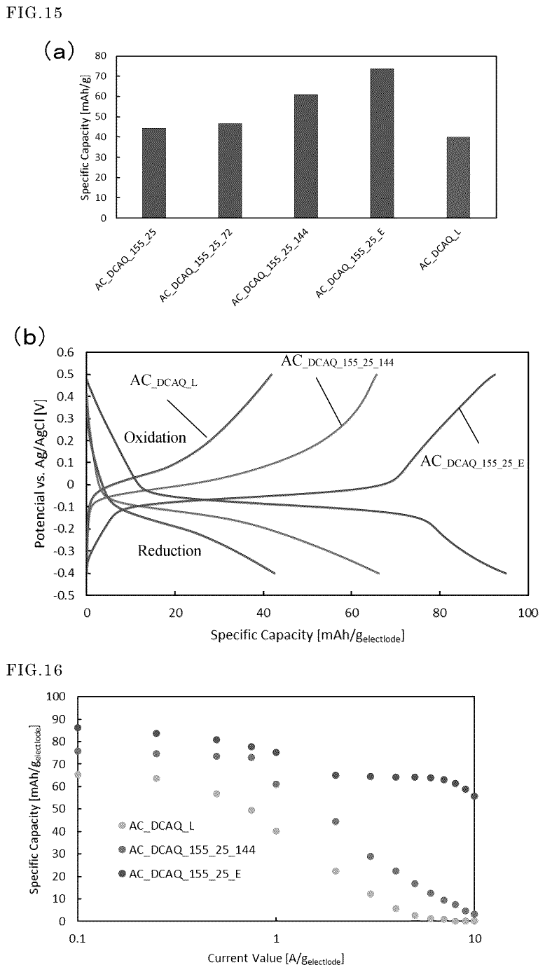

Electrochemical measurements were performed in a half-cell battery to determine the specific capacities, the rate properties, and the cycle properties. The sample 2-4 (AC_DCAQ_155_25), the sample 2-5 (AC_DCAQ_155_25_72), the sample 2-6 (AC_DCAQ_155_25_144), the sample 2-8 (AC_DCAQ_155_25_E), and the comparative sample 2 (AC_DCAQ_L) prepared by liquid impregnation were used for the measurements. The measurements were performed using the equipment as shown in FIG. 3 and each of the tests was conducted as in Example 1. At this time, one manufactured using the sample of DCAQ instead of the sample of CHL from Example 1 is used as the working electrode WE. The results from measurements of specific capacity are shown in FIG. 15(a). As shown in FIG. 15(a), all of the samples were found to have a specific capacity higher than the comparative sample 2 prepared by liquid impregnation. In particular, the sample 2-8 was found to have a specific capacity higher than the comparative sample 2 by a factor of about 1.9.

The relationships between potential and specific capacity (redox curves) for the sample 2-6 (AC_DCAQ_155_25_144), the sample 2-8 (AC_DCAQ_155_25_E) having a particularly large specific capacity, and the comparative sample 2 (AC_DCAQ_L) prepared by liquid impregnation are shown in FIG. 15(b). As shown in FIG. 15(b), the sample 2-6 and the comparative sample 2 showed a higher oxidation potential and a lower reduction potential. For the sample 2-6, the extended impregnation time is believed to have resulted in layering of a large amount of DCAQ, which increased the interface resistance, increased the overvoltage, and decreased the specific capacity. In contrast, the sample 2-8 was found to have a lower overvoltage and a higher specific capacity. This may be because the impregnation in the supercritical carbon dioxide maintains the adsorption state of DCAQ onto the pore surface of the activated charcoal through the π-π interaction.

The sample 2-8 (AC_DCAQ_155_25_E) having a large specific capacity, and the comparative sample 2 (AC_DCAQ_L) prepared by liquid impregnation were subjected to pyrolysis gas chromatography to measure the amount of Cl element for calculating the impregnation support amount of DCAQ. The results are shown in Table 5. As shown in Table 5, the impregnation supporting amount of DCAQ was found to be about 27% for the comparative sample 2, whereas about 38% for the sample 2-8, which was about 1.41 times higher.

TABLE 5

| Sample Name | Cl [wt %] | DCAQ [wt %] |
|---|---|---|
| AC_{_{—}}_{DCAQ}_{_{—}}_{L} | 6.9 | 27 |
| AC_{_{—}}_{DCAQ}_{_{—}}₁₅₅_{_{—}}₂₅_{_{—}}_{E} | 9.6 | 38 |

Using the impregnation support amount of DCAQ in Table 5, the utilization rates of DCAQ at the specific capacities shown in FIG. 15(a) were determined and are shown in Table 6. As shown in Table 6, the sample 2-8 was found to show that nearly 100% of DCAQ contributed to the specific capacity. This may be because DCAQ was supported in a manner that the pores were not occluded. This can allow the electrolyte to reach the supported DCAQ, leading to sufficient oxidation and reduction. It is noted that the utilization rate of the sample 2-8 in Table 6 is more than 100%. This may be because in FIG. 15(b), the slope representing the electric double-layer capacity before the reduction of DCAQ is completed is larger than the slope representing the electric double-layer capacity after the reduction is completed.

TABLE 6

| | Theoretical | Practical | Utilization |
|---|---|---|---|
| | capacity | amount | rate |
| Sample Name | [mAh/g] | [mAh/g] | [%] |
| AC_{_{—}}_{DCAQ}_{_{—}}_{L} | 52.04 | 40.18 | 77.20 |
| AC_{_{—}}_{DCAQ}_{_{—}}₁₅₅_{_{—}}₂₅_{_{—}}_{E} | 72.41 | 73.71 | 104.1 |

The results of the rate properties for the sample 2-6 (AC_DCAQ_155_25_144), the sample 2-8 (AC_DCAQ_155_25_E) having a higher specific capacity, and the comparative sample 2 (AC_DCAQ_L) prepared by liquid impregnation are shown in FIG. 16. As shown in FIG. 16, the sample 2-6 and the sample 2-8 were found to maintain a higher specific capacity at any current densities as compared with the comparative sample 2. In particular, it was found that the specific capacity of the sample 2-8 was large; for example, the specific capacity was about 7 times larger than that of the comparative sample 2 at a current density of 3 A/g. The specific capacity of the sample 2-8 was found to decrease in a different way than those of the sample 2-6 and the comparative sample 2 at 2 A/g_{electlode} or higher. This may be because the interface resistance was low, and the overvoltage was high. In addition, the sample 2-6 was found to maintain a high specific capacity up to 1 A/g_{electlode}, but the specific capacity was found to be lowered significantly at 1 A/g_{electlode} or higher. This may be due to an increased interface resistance caused by multiple layers of DCAQ.

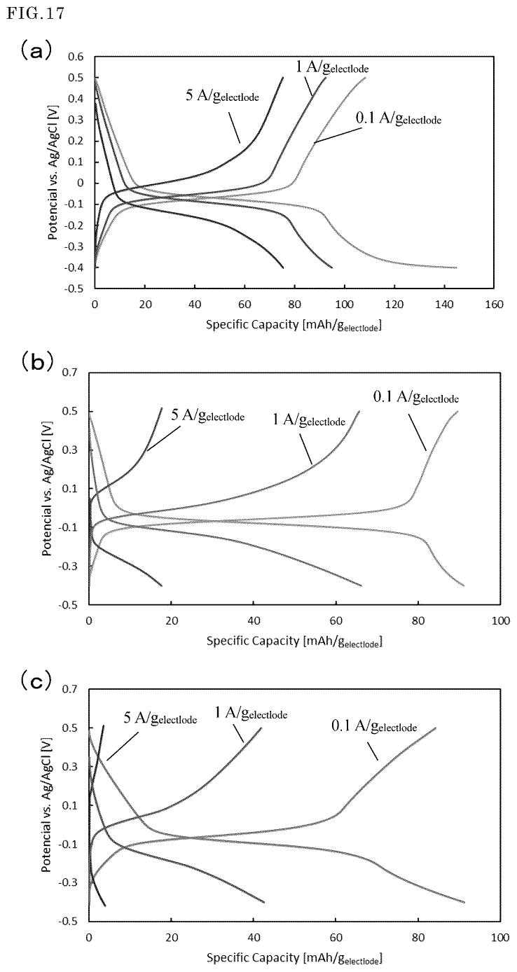

Further, the redox curves of these samples at 0.1 A/g_{electlode}, 1 A/g_{electlode}, and 5 A/g_{electlode} are shown in FIGS. 17(a) to 17(c), respectively. As shown in FIGS. 17(a) to 17(c), it was found that the sample 2-8 had a low overvoltage and maintained the specific capacity even when the current value was elevated, whereas the sample 2-6 and the comparative sample 2 had an increased overvoltage and were not able to maintain the specific capacity when the current value was elevated.

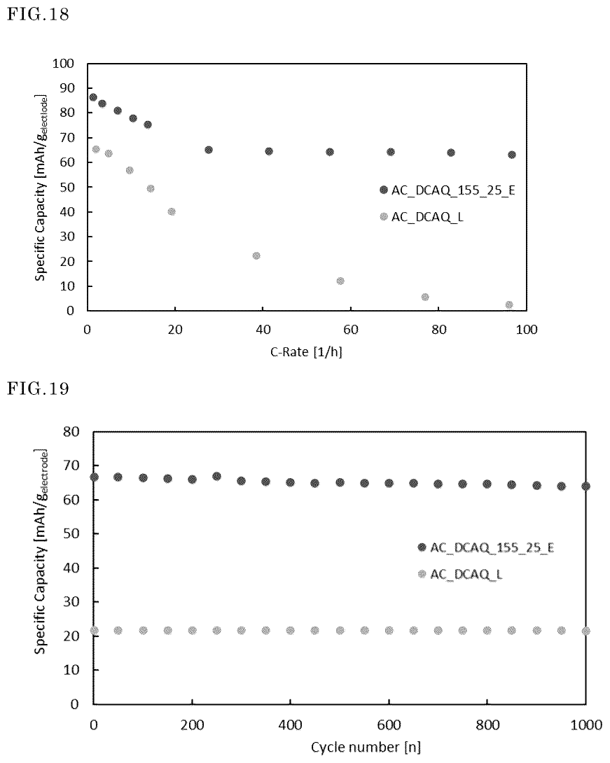

Moreover, the rate properties per C-rate of the sample 2-8 (AC_DCAQ_155_25_E) and the comparative sample 2 (AC_DCAQ_L) are shown in FIG. 18. As shown in FIG. 18, the specific capacity of the sample 2-8 at the C-rate was also found to be larger than that of the comparative sample 2 at all the rates. Moreover, it was also found that the difference in the specific capacities increased as the C-rate increased due to the effects of overvoltage. This may show that DCAQ can be efficiently redoxed even at high rates for the sample 2-8 prepared by supercritical carbon dioxide.

The results of the cycle properties for the sample 2-8 (AC_DCAQ_155_25_E) and the comparative sample 2 (AC_DCAQ_L) prepared by liquid impregnation are shown in FIG. 19. As shown in FIG. 19, the sample 2-8 was found to have excellent durability with 94% of the specific capacity retained after 1000 cycles. The sample 2-8 was also found to have a specific capacity higher than the comparative sample 2 by 40 mAh/g_{electrode} or more even after 1000 cycles. This may be due to the more robust adsorption of DCAQ supported on the pore surface of the activated charcoal by virtue of the π-π interaction.

### [Measurements of Pore Size Distribution]

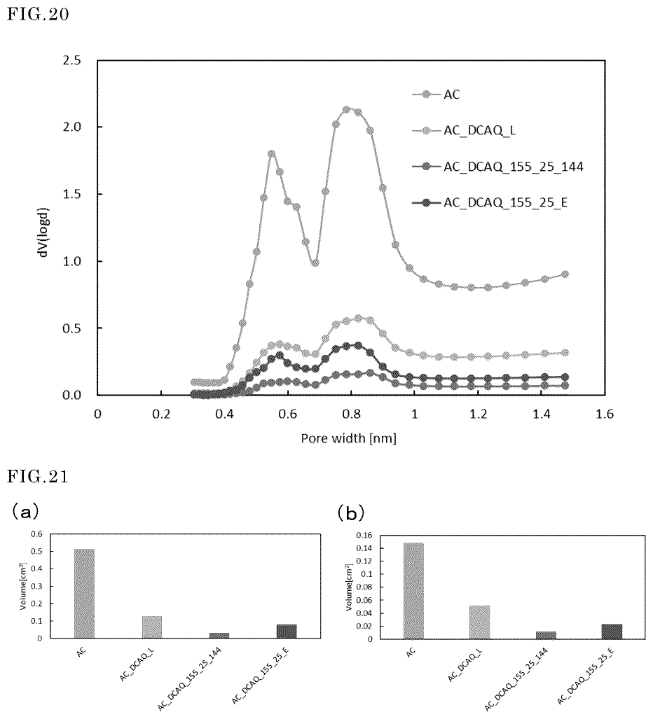

The sample 2-6 (AC_DCAQ_155_25_144), the sample 2-8 (AC_DCAQ_155_25_E) having a large support amount of DCAQ, the comparative sample 2 (AC_DCAQ_L) prepared by liquid impregnation, and the activated charcoal (AC) were subjected to the measurements of pore size distribution as in Example 1. The results from the measurements of pore size distribution are shown in FIG. 20. The pore volume of pores having a diameter of 1 nm or less, and the pore volume of pores having a diameter of 1 nm or more (1 to 1.5 nm) were also calculated for each sample from these results, and are shown in FIGS. 21(a) and 21(b), respectively. It is noted that the molecular size of DCAQ is 5.94×7.88 angstrom.

As shown in FIGS. 20 and 21, the sample 2-6, the sample 2-8, and the comparative sample 2 were found to have smaller pore volumes than the activated charcoal at all of the pore sizes. In the range of pore diameters between 1 nm or more (1 to 1.5 nm) and 1 nm or less, the sample 2-6 was found to have a smaller pore volume than the comparative sample 2. When comparing this result with FIG. 13, it can be assumed that the incremental amount of DCAQ in the impregnation support amount is supported deeper into the pores. The sample 2-6 was found to have a smaller pore volume than the sample 2-8. This suggests that in the sample 2-6, the supported DCAQ occluded the pores having a diameter of 1 nm or more (1 to 1.5 nm) whereas in the sample 2-8, DCAQ was supported in such a way that the pores were not occluded.

Further, as shown in FIG. 21(b), the sample 2-6 was found to show about 92% decrease in the pore volume with a diameter of 1 nm or more (1 to 1.5 nm) of the activated charcoal, and the sample 2-8 was found to show about 84% decrease in the pore volume with a diameter of 1 nm or more (1 to 1.5 nm) of the activated charcoal. Further, as shown in FIG. 21(a), the sample 2-6 was found to show about 93% decrease in the pore volumes with a diameter of 1 nm or less of the activated charcoal, and the sample 2-8 was found to show about 84% decrease in the pore volume with a diameter of 1 nm or less of the activated charcoal. These results from the measurements of the pore size distribution suggest that the DCAQ supported in these pores may have a significant impact on the improvement of the specific capacity and other properties.

### Example 3

### [Electrochemical Measurements in Full-Cell Battery]

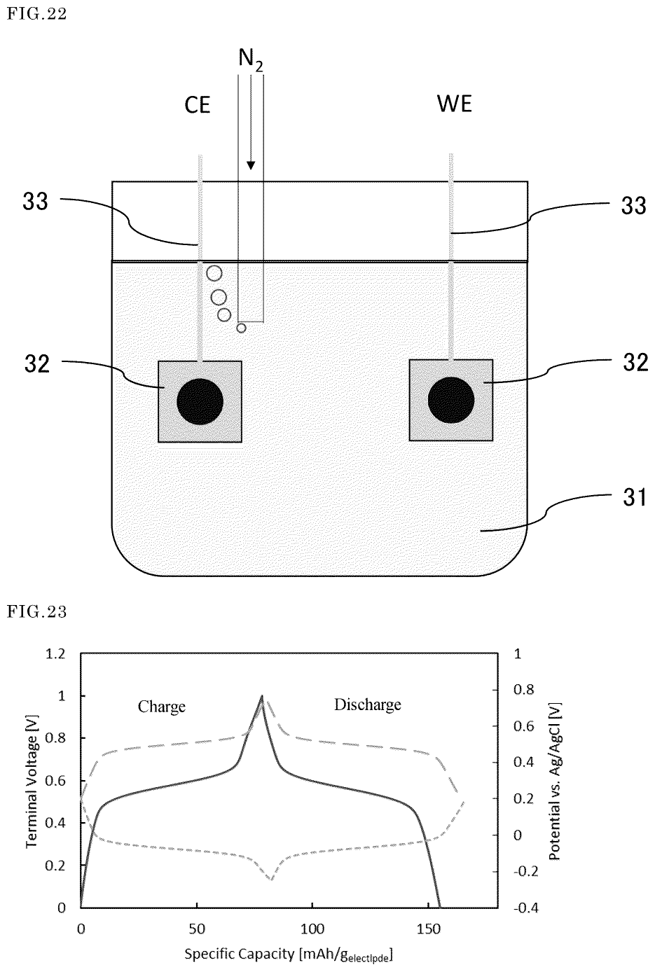

Electrochemical measurements were performed in a full-cell battery to determine the energy densities, the rate properties, and the cycle properties. For the measurements, one including the sample 1-8 (AC_CHL_105_15) manufactured as a working electrode in a half-cell battery of Example 1 was used as a working electrode WE (positive electrode; Positive) as shown in FIG. 22. The working electrode WE was prepared as follows: the powder of a CHL sample was mixed with a polytetrafluoroethylene (PTFE) binder in a weight ratio of 9:1 to form a paste, which was rolled thinly to 0.2 mg/mm², and then punched out in a diameter of 5.5 mm, and pressure-fit on the gold mesh 32 which was welded to the gold wire 33. One including the sample 2-8 (AC_DCAQ_155_25_E) manufactured as a working electrode in a half-cell battery of Example 2 was used as a counter electrode CE (negative electrode; Negative). The counter electrode CE was prepared as follows: the powder of a DCAQ sample was mixed with a polytetrafluoroethylene (PTFE) binder in a weight ratio of 9:1 to form a paste, which was rolled thinly to 0.05 mg/mm², and then punched out in a diameter of 11 mm, and pressure-fit on the gold mesh 32 which was welded to the gold wire 33. As the electrolytic solution 31, an aqueous solution of 0.5 M H₂SO₄ bubbled with N₂ gas for 2 hours to remove dissolved oxygen was used. Measurements were performed in the electrolytic solution 31 under nitrogen bubbling using an electrochemical measuring equipment (“SI 1280-2” from TOYO Corporation).

For the measurement of energy density in a full-cell battery, constant current measurements were conducted in the range of 0 to 1 V at 0.26, 0.28, and 2.6 A/g_{electlode/2} to obtain an energy density at the fifth cycle. The redox curve and the charge-discharge curve of the positive and negative electrodes at 0.28 A/g are shown in FIG. 23. As shown in FIG. 23, the charge-discharge curve was found to have a plateau region at around 0.6 V, which corresponded to the difference in redox potentials of the both electrodes. The energy density was found to be 20.85 Wh/g, which was comparable to the energy density of a lead battery.

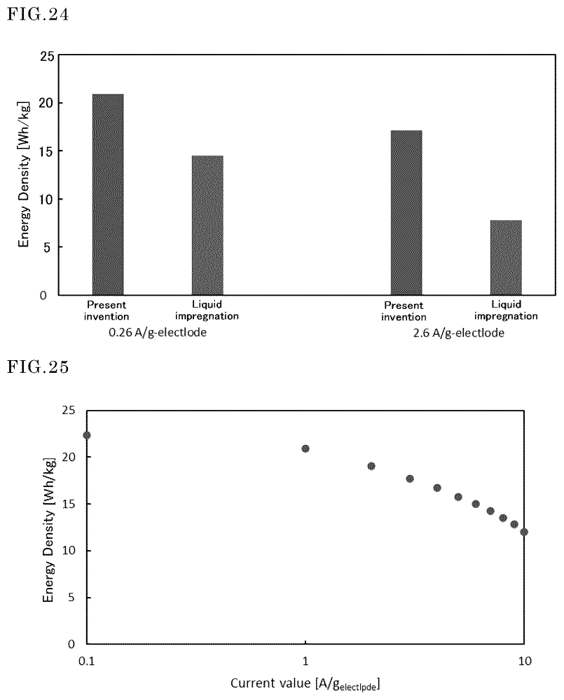

The energy densities at 0.26 A/g and 2.6 A/g are shown in FIG. 24. It is noted that the energy densities when electrode materials having CHL and DCAQ impregnated into activated charcoal by liquid impregnation as obtained in Non-Patent Literature 1 were used are also shown in FIG. 24 for comparison. As shown in FIG. 24, the energy density in a full-cell battery prepared by impregnation in supercritical carbon dioxide was found to be 1.44 times higher at 0.26 A/g and 2.20 times higher at 2.6 A/g as compared to those prepared by liquid impregnation. This may be because the impregnation support amounts of both of CHL and DCAQ were increased at both of the positive and negative electrodes, and the overvoltage was decreased by virtue of a decreased interface resistance.

The results of the rate properties in a full-cell battery are shown in FIG. 25. It is noted that for measurements of rate properties, constant current measurements were conducted in the range of 0 to 1.2 V at 0.1 to 10 A/g_{electlode/2} to obtain an energy density at the second cycle. As shown in FIG. 25, the rate of decrease in energy density due to increased rates was kept small, showing that the high rate properties of the positive and negative electrodes were maintained.

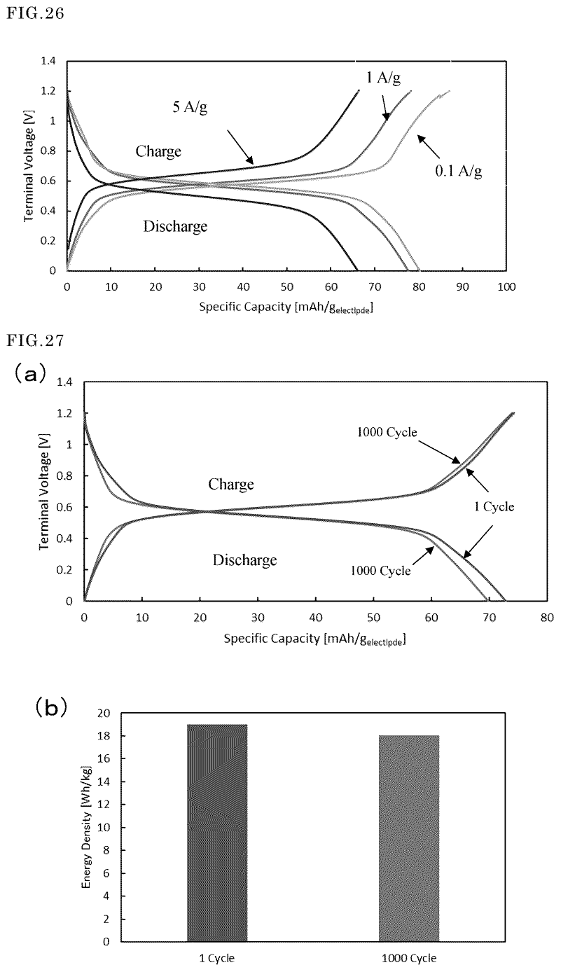

Further, the charge-discharge curves at 0.1 A/g_{electlode/2}, 1 A/g_{electlode/2}, and 5 A/g_{electlode/2} are shown in FIG. 26. As shown in FIG. 26, it was found that the potential at the plateau region was higher in the charge curve and lower in the discharge curve, and the overvoltage was elevated. This further indicated that the charge-discharge curve was short. These results also showed that the energy density decreased as the rate increased.

The results of the cycle properties in a full-cell battery are shown in FIG. 27. It is noted that for the measurements of the cycle properties, constant current measurements were conducted for 1000 cycles in the range of 0 to 1.2 V at 2 A/g_{electlode/2}, and the first cycle was compared with the 1000th cycle. As shown in FIG. 27(a), there was no significant difference in the potential and length in the plateau region between the first cycle and the 1000th cycle. As shown in FIG. 27(b), the energy density at the first cycle was 19.01 Wh/g, and the energy density at the 1000th cycle was 18.05 Wh/g, showing that the decrease in energy density was only 5%.

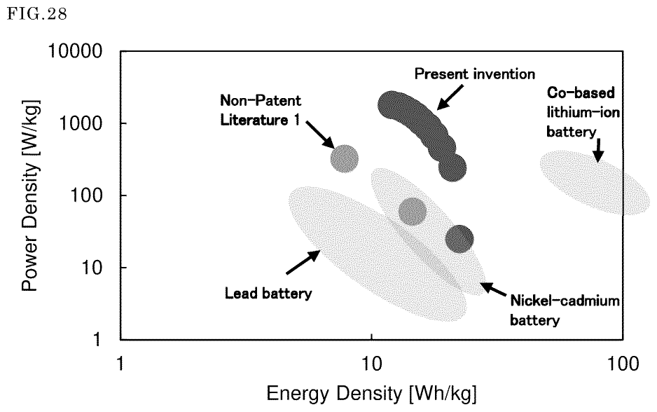

The power densities of the full-cell batteries were calculated from the obtained rate properties, and shown in FIG. 28. It is noted that FIG. 28 also shows the power density of each of the conventional batteries, and the power densities of the full-cell batteries including the electrode materials prepared by liquid impregnation according to Non-Patent Literature 1. As shown in FIG. 28, it was found that the energy densities of the full-cell batteries were about the same as those of the lead battery and the nickel-cadmium battery, and the power densities were much superior to those of the lead battery, the nickel-cadmium battery, and the Co-based lithium-ion battery.

### REFERENCE SIGNS LIST

11 Porous Carbon Material
12 Organic Active Material
21 Box (made of Copper)
22 Container (made of SUS316)
23 Water Tank
24 Thermometer
25 Tank
26 Pressure Gage
31 Electrolytic Solution
32 Gold Mesh
33 Gold Wire

1. A composite material for electrodes, comprising:
a porous carbon material, and
an organic active material supported within pores of the porous carbon material,
wherein the organic active material is included in an amount of 28 wt % or more relative to the total weight of the porous carbon material and the organic active material.

2. The composite material for electrodes according to claim 1, wherein the organic active material is included in an amount of 35 wt % or more relative to the total weight of the porous carbon material and the organic active material.

3. The composite material for electrodes according to claim 1, wherein the organic active material is supported within the pores so as to occupy 70% or more of pore volume with a diameter of 1 to 1.5 nm among the pores of the porous carbon material.

4. The composite material for electrodes according to claim 1, wherein the organic active material is supported within the pores so as to occupy 80% or more of the pore volume with a diameter of 1 to 1.5 nm among the pores of the porous carbon material.

5. The composite material for electrodes according to claim 3, wherein the organic active material is supported within the pores so as to occupy 60% or more of the pore volume with a diameter of less than 1 nm among the pores of the porous carbon material.

6. The composite material for electrodes according to claim 3, wherein the organic active material is supported within the pores so as to occupy 80% or more of the pore volume with a diameter of less than 1 nm among the pores of the porous carbon material.

7. The composite material for electrodes according to claim 1, wherein the organic active material comprises a quinone compound, croconic acid, or metal phthalocyanine.

8. The composite material for electrodes according to claim 1, wherein the porous carbon material consists of activated charcoal.

9. An electricity storage device, having an electrode material comprising the composite material for electrodes according to claim 1.

10. A method of manufacturing a composite material for electrodes, the method comprising: maintaining a porous carbon material and an organic active material for a predetermined time in supercritical carbon dioxide at 70° C. or more to 170° C. or less and 10 MPa or more to 30 MPa or less, or 90° C. or more to 170° C. or less and 10 MPa or more to 20 MPa or less to impregnate the organic active material within pores of the porous carbon material, thereby manufacturing the composite material for electrodes having the organic active material supported within the pores of the porous carbon material.

11. The method of manufacturing a composite material for electrodes according to claim 10, wherein the composite material for electrodes for use as positive electrodes is manufactured using the supercritical carbon dioxide at 70° C. or more to 90° C. or less and 10 MPa or more to 30 MPa or less, or 90° C. or more to 130° C. or less and 10 MPa or more to 20 MPa or less.

12. The method of manufacturing a composite material for electrodes according to claim 10, wherein the composite material for electrodes for use as negative electrodes is manufactured using the supercritical carbon dioxide at 130° C. or more to 170° C. or less and 10 MPa or more to 30 MPa or less.

13. The method of manufacturing a composite material for electrodes according to claim 10, wherein the predetermined time is 3 hours or more.

14. The method of manufacturing a composite material for electrodes according to claim 10, wherein the predetermined time is 20 hours or more.

15. The method of manufacturing a composite material for electrodes according to claim 10, wherein a polar solvent as an entrainer is added to the supercritical carbon dioxide and maintained for the predetermined time, thereby manufacturing the composite material for electrodes.

16. The method of manufacturing a composite material for electrodes according to claim 12, wherein the predetermined time is 60 hours or more, and the composite material for electrodes for use as negative electrodes is manufactured.

17. The method of manufacturing a composite material for electrodes according to claim 10, wherein the organic active material comprises a quinone compound, croconic acid, or metal phthalocyanine.

18. The method of manufacturing a composite material for electrodes according to claim 10, wherein the porous carbon material consists of activated charcoal.
